(19) United States
(12) Patent Application Publication
(10) Pub. No.: US 2016/0042073 A1
(43) Pub. Date: Feb. 11, 2016

(54) METHOD AND SYSTEM FOR NEWS PERSONALIZATION USING MERCHANT TARGETING

(71) Applicant: MasterCard International Incorporated, New York, NY (US)

(72) Inventor: Justin X. HOWE, San Francisco, CA (US)

(21) Appl. No.: 14/452,899

(22) Filed: Aug. 6, 2014

(51) Int. Cl. G06F 17/30; H04L 29/08

(52) U.S. Cl. CPC G06F 17/30867; H04L 67/10

(57) ABSTRACT

A method for filtering news content includes: storing a consumer profile, the profile including data related to a consumer; storing, in the consumer profile, a plurality of transaction data entries, each entry including data related to a payment transaction involving the related consumer including a merchant identifier and transaction data; receiving a list of news content items, the list of news content items including data related to a plurality of news content items including publication data; identifying one or more news content items in the list of news content items where the included publication data corresponds to at least one of the merchant identifier and transaction data in one or more transaction data entries stored in the consumer profile; filtering the identified one or more news content items out of the list of news content items; and transmitting the filtered list of news content items.

### FIELD

The present disclosure relates to the filtering of news content, specifically the filtering of news from a publication that a consumer already has a subscription to as identified using transaction data associated with the consumer.

### BACKGROUND

Consumers may get their news from a variety of sources. Traditionally, consumers got their news from newspapers, magazines, and other periodicals, as well as by word-of-mouth from other people. As technology developed, each new type of technology brought with it a new way to receive the news, from radio to television to the Internet. With each method of distribution, multiple providers often enable consumers to choose among news providers and content distributers to receive news from a source whose style, content, or presentation they prefer.

In order to provide a better user experience to consumers, some methods have been developed in order to provide customized news to a consumer. For example, one method includes selecting personalized news content to provide to a consumer based on their purchase behavior, as described in detail in U.S. patent application Ser. No. 14/147,139, entitled “Method and System for Personalized News Recommendations Based on Purchase Behavior,” filed on Jan. 3, 2014, by Jean-Pierre Gerard et al., which is herein incorporated by reference in its entirety.

However, while methods and systems for providing personalized news may select news content to provide to a consumer based on their purchase behavior, it may be advantageous to filter the selected news content that the consumer may have already seen. For example, a consumer may get their news from multiple sources, such as a local newspaper as well as an Internet website that offers personalized news. The consumer may read several news stories in their local newspaper over their morning coffee, and then browse their personalized news website once they arrive at their workplace. The personalized news website may provide them with their personalized news, but the news may include a number of articles also included in the local newspaper that the consumer already read. As a result, the consumer may receive repeats of already viewed content, and may thereby potentially miss out on additional content.

Thus, there is a need for a technical solution that automatically filters news content based on existing consumer subscriptions to additional news services.

### SUMMARY

The present disclosure provides a description of systems and methods for filtering of news content.

A method for filtering news content includes: storing, in a profile database, a consumer profile, wherein the consumer profile includes data related to a consumer; storing, in the consumer profile, a plurality of transaction data entries, wherein each transaction data entry includes data related to a payment transaction involving the related consumer including at least a merchant identifier and transaction data; receiving, by a receiving device, a list of news content items, wherein the list of news content items includes data related to a plurality of news content items including at least publication data; identifying, by a processing device, one or more news content items in the list of news content items where the included publication data corresponds to at least one of the merchant identifier and transaction data in one or more transaction data entries stored in the consumer profile; filtering, by the processing device, the identified one or more news content items out of the list of news content items; and transmitting, by a transmitting device, the filtered list of news content items.

A system for filtering news content includes a profile database, a receiving device, a processing device, and a transmitting device. The profile database is configured to store a consumer profile, wherein the consumer profile includes data related to a consumer including a plurality of transaction data entries, wherein each transaction data entry includes data related to a payment transaction involving the related consumer including at least a merchant identifier and transaction data. The receiving device is configured to receive a list of news content items, wherein the list of news content items includes data related to a plurality of news content items including at least publication data. The processing device is configured to: identify one or more news content items in the list of news content items where the included publication data corresponds to at least one of the merchant identifier and transaction data in one or more transaction data entries stored in the consumer profile; and filter the identified one or more news content items out of the list of news content items. The transmitting device is configured to transmit the filtered list of news content items.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for the filtering of news content in accordance with exemplary embodiments.

FIG. 2 is a block diagram illustrating the processing server of FIG. 1 for filtering news content accordance with exemplary embodiments.

FIG. 3 is a flow diagram illustrating a process for filtering news content using the processing server of FIG. 2 in accordance with exemplary embodiments.

FIG. 4 is a diagram illustrating the filtering of news content based on consumer subscription data in accordance with exemplary embodiments.

FIG. 5 is a flow chart illustrating an exemplary method for filtering news content in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

### System for Filtering News Content

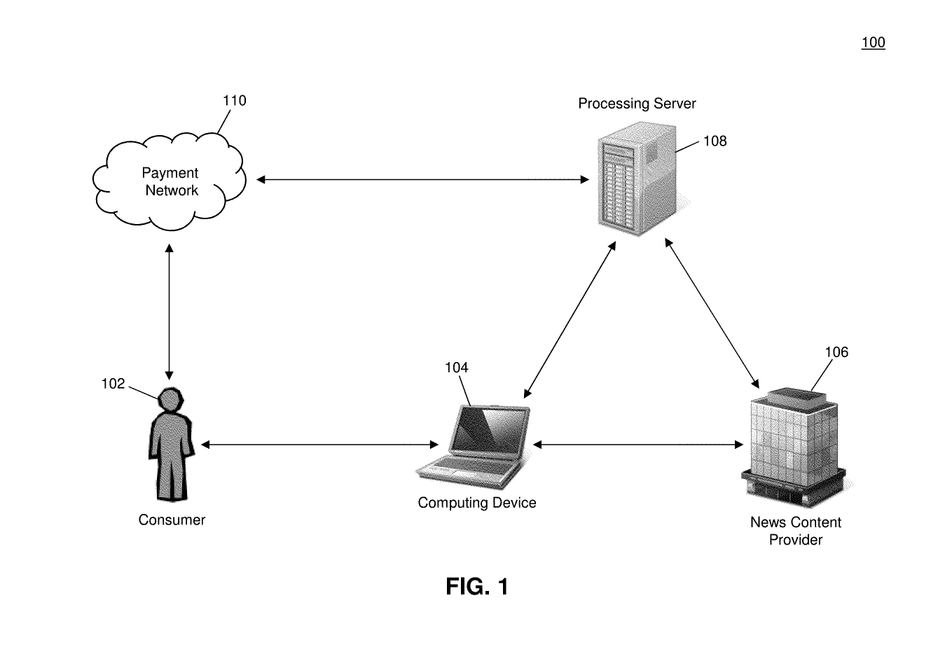

FIG. 1 illustrates a system 100 for the filtering of news content based on subscription data for a consumer as indicated in their transaction history.

A consumer 102 may access news over the Internet or other network using a computing device 104. The computing device 104 may be a desktop computer, laptop computer, notebook computer, tablet computer, cellular phone, smart phone, smart watch, smart television, personal digital assistant, or other type of computing device suitable for performing the functions disclosed herein as will be apparent to persons having skill in the relevant art. The computing device 104 may be configured to communicate over one or more networks, such as the Internet, to receive news from a news content provider 106.

The news content provider 106 may be configured to provide news to the computing device 104 for viewing by the consumer 102. In some instances, news content identified by the news content provider 106 may be targeted to the computing device 104 and/or consumer 102, such as selecting news content based on preferences of the consumer 102 provided by the consumer 102 and/or identified by the news content provider 106 based on consumer feedback, consumer selection of provided content items, etc.

The system 100 may also include a processing server 108. The processing server 108, discussed in more detail below, may be configured to filter the news content provided by the news content provider 106 to the computing device 104 based on the source of the news content and transaction history of the consumer 102 that indicates that the consumer 102 may have already received the filtered content via another news source.

In some embodiments, the news content provider 106 may provide the news content to the processing server 108, and the processing server 108 may filter the news content and then provide the filtered content directly to the computing device 104. In an alternative embodiment, the processing server 108 may return the news content that has been filtered out to the news content provider 106 to then provide to the computing device 104. In yet another embodiment, the processing server 108 may identify data used for filtering the news content, and may provide the data to the news content provider 106 for filtering of the news content. In some embodiments, the processing server 108 may be a part of the news content provider 106. In still other embodiments, the news content provider 106 might alert the consumer 102 as to the omitted content (e.g., by content title, author, publisher, content identifier) with hyperlinks to the content.

The processing server 108 may be configured, as discussed in more detail below, to filter news content based on publication data of the news content (e.g., publisher, author, content name, content identifier, etc.) and transaction data for payment transactions involving the consumer 102. The transaction data may be obtained by the processing server 108 from a payment network 110. The payment network 110 may be configured to process payment transactions involving the consumer 102. The payment network 110 may identify transaction data for the process payment transactions and transmit the transaction data to the processing server 108. In some instances, the payment network 110 may identify and transmit transaction data for a plurality of transaction accounts associated with the consumer 102.

The processing server 108 may receive the transaction data and may then filter news content based on the transaction data. For example, the transaction data may include data indicating a subscription to a specific news source. The processing server 108 may then filter news content received from the news content provider 106 that comes from the specific news source to which the consumer 102 already subscribes. In instances where the received transaction data may include product data, the product data may indicate an author, content name, content identifier, or other value that may be used for filtering news content received from the news content provider 106. The processing server 108 may then filter the news content accordingly based on the information included in and/or associated with the news content and the information included in the received transaction data.

The filtered news content may be provided to the computing device 104 by the news content provider 106 or the processing server 108, and then viewed by the consumer 102. In some instances, the consumer 102 may provide feedback regarding the filtering, which may be used by the processing server 108 to improve the filtering. For instance, the consumer 102 may indicate if a filtered publication was purchased without a subscription, and thus should not be regularly filtered, if a filtered publication that was subscribed to was canceled and content from that publication no longer filtered, if certain types of stories from a publication should not be filtered (e.g., because the consumer 102 does not read a section of the subscribed publication, based on access history provided by the content provider/publisher, both specific to the publisher and more specific to the identified content), etc. The processing server 108 may receive the feedback and may generate one or more filtering rules for use in filtering the news content for the consumer 102 based on the received feedback.

By filtering news content based on subscription data identified via a consumer's transaction history, the processing server 108 may be able to provide for more specialized filtering and targeting of news content to consumers. The filtering of the content may result in a consumer 102 not receiving duplicate content, which may improve the overall consumer experience as well as increase the amount of targeted content that can reach the consumer 102. Furthermore, as the consumer experience is improved, business for news content providers 106 utilizing the filtering of the processing server 108 may also be improved.

### Processing Server

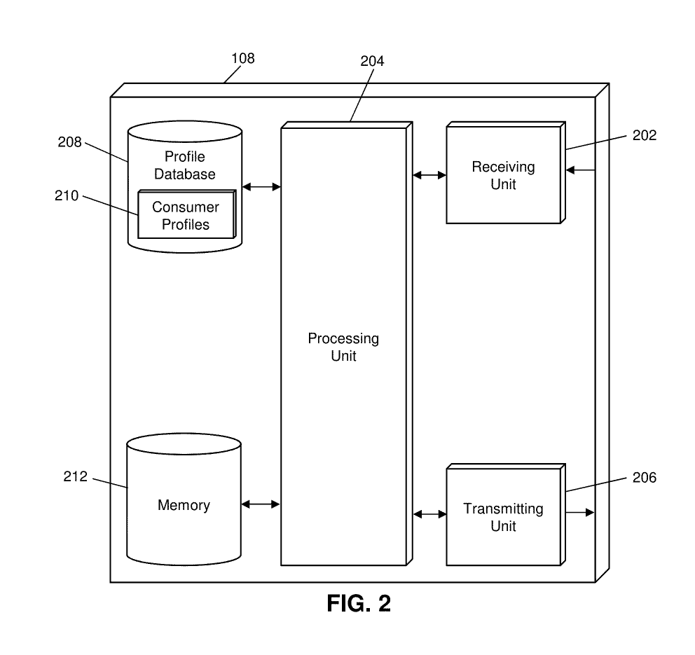

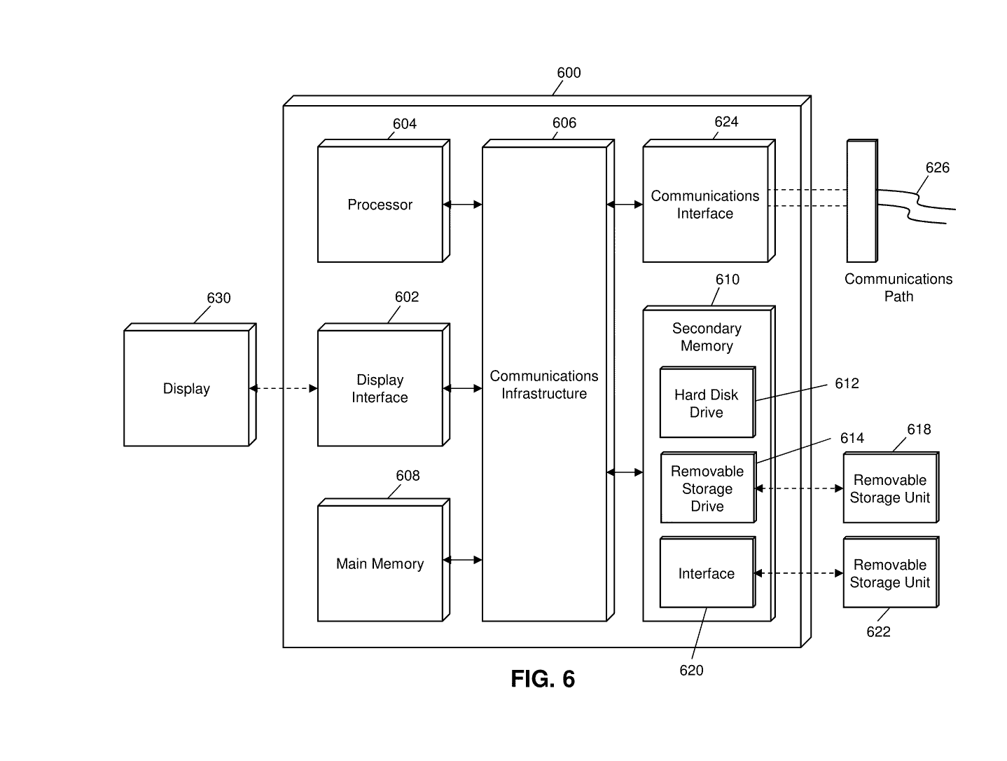

FIG. 2 illustrates an embodiment of the processing server 108 of the system 100. It will be apparent to persons having skill in the relevant art that the embodiment of the processing server 108 illustrated in FIG. 2 is provided as illustration only and may not be exhaustive to all possible configurations of the processing server 108 suitable for performing the functions as discussed herein. For example, the computer system 600 illustrated in FIG. 6 and discussed in more detail below may be a suitable configuration of the processing server 108.

The processing server 108 may include a profile database 208. The profile database 208 may be configured to store a plurality of consumer profiles 210. Each consumer profile 210 may include data related to a consumer 102 including at least a plurality of transaction data entries. Each transaction data entry may include data related to a payment transaction involving the related consumer 102 and include at least a merchant identifier and transaction data. The merchant identifier may be a unique value suitable for the identification of a merchant involved in the payment transaction, such as a merchant identification number, registration number, serial number, etc. The transaction data may include a transaction amount, transaction time and/or date, product data (e.g., author name, article name, content type, publication name, issue name, issue volume, publication date, etc. for news content), etc.

Each consumer profile 210 may also include a consumer identifier. The consumer identifier may be a unique value suitable for identification of the consumer profile 210 and/or related consumer 102. The consumer identifier may be an identification number, username, e-mail address, phone number, device identifier (e.g., associated with the computing device 104, such as a media access control address), transaction account number, etc. The consumer identifier may be used in identification of the consumer profile 210 for storage of received transaction data and/or identification of the consumer profile 210 for filtering of news content.

In some instances, each consumer profile 210 may include additional data associated with the related consumer 102. For example, the consumer profile 210 may include feedback data associated with feedback provided by the consumer 102 regarding the filtering. In another example, the consumer profile 210 may include consumer preferences regarding news, such as for use in identifying specialized news content for the consumer 102 using methods and systems that will be apparent to persons having skill in the relevant art. In yet another example, the consumer profile 210 may include subscription information regarding news subscriptions for the related consumer 102 as identified based on the transaction data entries included in the consumer profile 210. Additional data that may be included in the consumer profile 210 will be apparent to persons having skill in the relevant art.

The processing server 108 may also include a receiving unit 202. The receiving unit 202 may be configured to receive data over one or more networks via one or more network protocols. The receiving unit 202 may receive transaction data from the payment network 110 for storage in the respective consumer profile 210 as transaction data entries. The receiving unit 202 may also receive news content from the news content provider 106 for filtering. In some instances, the receiving unit 202 may receive feedback from the computing device 104 and/or the news content provider 106 for storage in the corresponding consumer profile 210.

The processing server 108 may further include a processing unit 204. The processing unit 204 may be configured to filter received news content based on data included in a consumer profile 210. As discussed in more detail below, the processing unit 204 may identify one or more news subscriptions for the consumer 102 and/or may identify news content included in the received news content that the consumer 102 may have already been exposed to based on the transaction data entries included in the respective consumer profile 210. In some embodiments, the processing unit 204 may also be configured to further filter the news content based on consumer preferences, feedback data, and other data that may be included in the consumer profile 210.

The processing server 108 may additionally include a memory 212. The memory 212 may be configured to store data suitable for performing the functions disclosed herein. For example, the memory 212 may store one or more rules and/or algorithms for the identification of news subscriptions or received news content based on the transaction data entries included in a consumer profile 210. The memory 212 may also store rules for use in the filtering of news content based on consumer feedback and other data. Additional data that may be stored in the memory 212 will be apparent to persons having skill in the relevant art.

The processing server 108 may also include a transmitting unit 206. The transmitting unit 206 may be configured to transmit data over one or more networks via one or more network protocols. The transmitting unit 206 may transmit the filtered news content to the news content provider 106 and/or the computing device 104. In some embodiments, the transmitting unit 206 may transmit data identified by the processing unit 204 for use in filtering news content to the news content provider 106 for filtering by the news content provider 106.

It will be apparent to persons having skill in the relevant art that the components of the processing server 108 may be configured to perform additional functions in instances where the processing server 108 may perform functions of the news content provider 106. For example, if the processing server 108 is configured to identify news content for providing to the consumer 102 based on purchase behavior, the components of the processing server 108 may be further configured to perform functions necessary for the identification of news content as will be apparent to persons having skill in the relevant art.

### Process for Filtering News Content

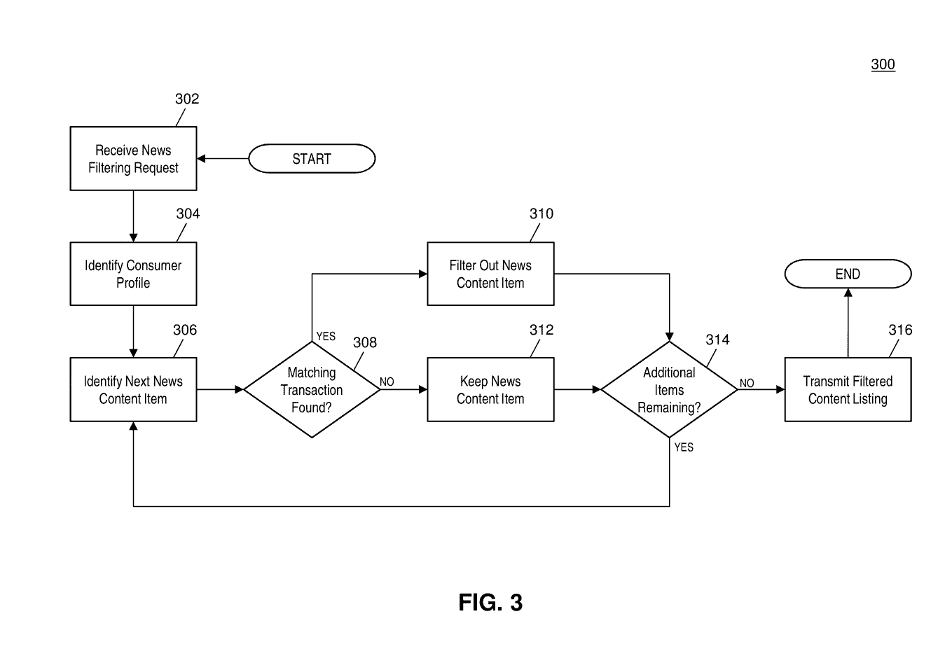

FIG. 3 illustrates a process 300 for the filtering of news content using consumer purchase behavior to identify content to which a consumer 102 may have already been exposed.

In step 302, the receiving unit 202 of the processing server 108 may receive a news filtering request from the news content provider 106. The news filtering request may include at least a plurality of news content items and a consumer identifier corresponding to a consumer profile 210 associated with the consumer 102 to which the filtered news content is to be provided. In step 304, the processing unit 204 of the processing server 108 may identify a consumer profile 210 in the consumer database 208 that includes the consumer identifier included in the received news filtering request.

In step 306, the processing unit 204 may identify the first news content item of the plurality of received news content items for filtering. In step 308, the processing unit 204 may analyze the transaction data entries stored in the identified consumer profile 210 to determine if there is a transaction data entry whose merchant identifier and/or transaction data correspond to publication data associated with the news content item. If a matching transaction data entry is found, then, in step 310, the news content item may be filtered out of the plurality of news content items. If no matching transaction data entry is found, then, in step 312, the processing unit 204 may keep the news content item in the plurality of news content items to be provided to the consumer 102.

Once the news content item has been kept or filtered based on the consumer's 102 transaction history, then, in step 314, the processing unit 204 may determine if additional news content items are included in the plurality of news content items still need to be analyzed for filtering. If there are still news content items remaining, then the process may return to step 306 where the next news content item is identified and then analyzed. Once there are no additional content items remaining, then, in step 316, a listing of the remaining news content items after filtering may be transmitted, by the transmitting unit 206 of the processing server 108, to the news content provider 106 in return to the originally received request. In some embodiments, the filtered news content items may alternatively, or additionally, be transmitted directly to the computing device 104 associated with the consumer 102.

### Filtering of News Content Items Based on Transaction History

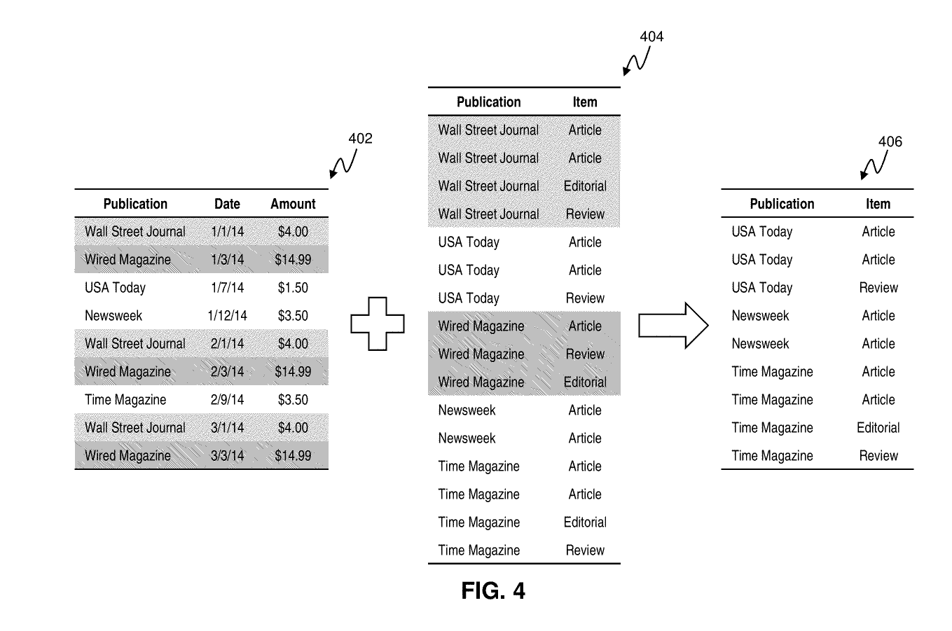

FIG. 4 is an illustration of the filtering of news content items based on consumer transaction history for use in the methods and systems discussed herein.

Table 402 of FIG. 4 illustrates a plurality of transaction data entries that may be included in the consumer profile 210 for a consumer 102 to whom news content is being provided. Each transaction data entry may include a transaction data, which, as in the example illustrated in FIG. 4, may include a publication name, or may include other data suitable for associating with a news content item, such as a publication date, issue date, volume number, volume name, author name, article name, article identifier, etc. Each transaction data entry may also include a transaction date and a transaction amount. The transaction date and transaction amount may be used by the processing unit 204 of the processing server 108 for identification of an active subscription to the associated publication.

For instance, in the example illustrated in FIG. 4, the transaction history may indicate that the consumer 102 has an active subscription to both the Wall Street Journal and Wired Magazine due to the amount of the transactions and the frequency of the transactions. The processing unit 204 may determine that there is no active subscription to USA Today, Newsweek, or Time Magazine due to the amounts and because there is no recurring payment to the publications. In some instances, a transaction amount may indicate an active subscription even if recurring payments are not identified. For example, an annual or lifetime subscription, which may only be charged once per year or only once ever, respectively, may be for a different amount than the purchase of a single issue, article, or volume of a publication. The processing unit 204 may thus identify such a subscription based on the transaction amount, despite a lack of recurring transactions.

Table 404 of FIG. 4 illustrates a plurality of news content items received by the receiving unit 202 from the news content provider 106 for filtering by the processing unit 204. Each news content item may include publication data, which in the example illustrated in FIG. 4 is the publication name, and a content type. The processing unit 204 may identify the news content items included in the table 404 that include a publication name that corresponds to a publication that the consumer 102 has an active subscription to, based on the transaction data entries included in table 402.

In the example illustrated in FIG. 4, the processing unit 204 may identify the news content items associated with the Wall Street Journal and Wired Magazine for filtering. The news content items associated with USA Today, Newsweek, and Time Magazine may not be filtered as the processing unit 204 determined that the consumer 102 did not have an active subscription to those publications and may not have been exposed to those content items.

Table 406 illustrates the list of filtered content items after filtering by the processing unit 204. The transmitting unit 206 of the processing server 108 may transmit the filtered content items to the news content provider 106 and/or the computing device 104 for providing to the consumer 102.

In some embodiments, the processing unit 204 may filter news content items from a publication in instances where the consumer 102 may not have an active subscription to that publication. For example, if the transaction date for a transaction data entry for a publication to which the consumer 102 does not have an active subscription corresponds to the publication date of a news content item, the news content item may still be filtered. For instance, the consumer 102 may purchase a Time Magazine with a publication date of Mar. 6, 2014, and the received news content items may include two articles from Time Magazine with a publication date of Mar. 6, 2014. The processing unit 204 may filter the two articles, as the transaction data indicates that the consumer 102 purchased the magazine including the articles, even if the consumer 102 did not have an active subscription to Time Magazine.

### Exemplary Method for Filtering News Content

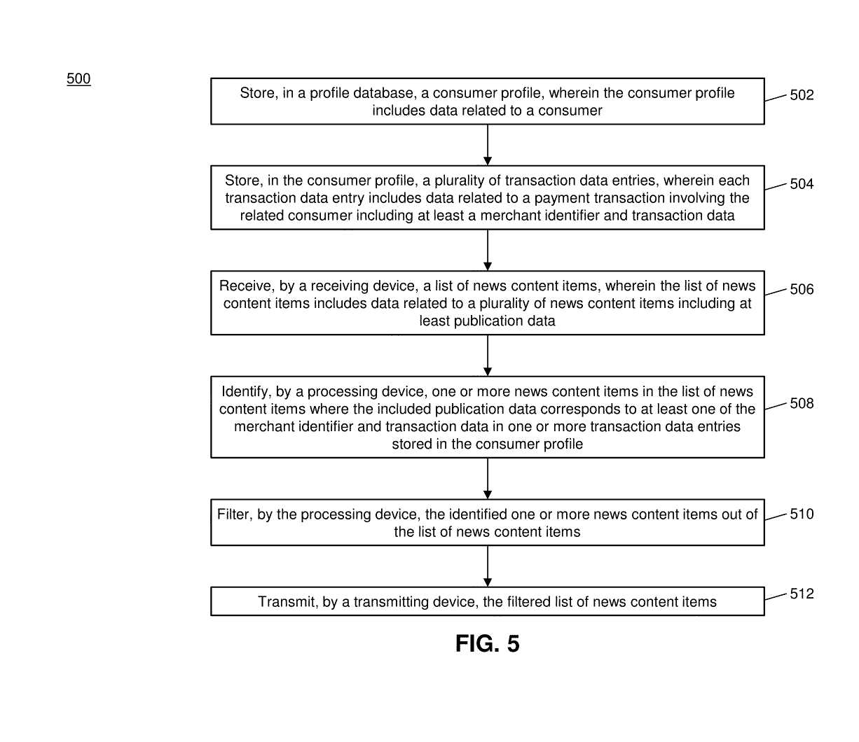

FIG. 5 illustrates a method 500 for filtering news content based on consumer transaction history.

In step 502, a consumer profile (e.g., consumer profile 210) may be stored in a profile database (e.g., the profile database 208), wherein the consumer profile 210 includes data related to a consumer (e.g., the consumer 102). In step 504, a plurality of transaction data entries may be stored in the consumer profile 210, wherein each transaction data entry includes data related to a payment transaction involving the related consumer 102 including at least a merchant identifier and transaction data. In one embodiment, the transaction data may include at least one of: a publication number, publication identifier, volume name, volume identifier, article name, article identifier, author name, and author identifier.

In step 506, a list of news content items may be received by a receiving device (e.g., the receiving unit 202), wherein the list of news content items includes data related to a plurality of news content items including at least publication data. In one embodiment, the publication data may include a merchant identifier associated with an entity associated with publishing of the corresponding news content item. In some embodiments, the publication data may include at least one of: a publication number, publication identifier, volume name, volume identifier, article name, article identifier, author name, and author identifier.

In step 508, one or more news content items in the list of news content items may be identified, by a processing device (e.g., the processing unit 204), where the included publication data corresponds to at least one of the merchant identifier and transaction data in one or more transaction data entries stored in the consumer profile 210. In one embodiment, the consumer profile 210 may further include a list of subscribed publications. In a further embodiment, the one or more news content items may include at least one news content item where the included publication data corresponds to a subscribed publication in the list of subscribed publications.

In step 510, the identified one or more news content items may be filtered, by the processing device 204, out of the list of news content items. In step 512, the filtered list of news content items may be transmitted by a transmitting device (e.g., the transmitting unit 206). In one embodiment, the filtered list of news content items may be transmitted to a display device (e.g., of the computing device 104) for display to the related consumer 102.

In one embodiment, the stored consumer profile 210 may be a specific consumer profile 210 of a plurality of consumer profiles stored in the profile database 208, and each consumer profile may include a consumer identifier. In a further embodiment, the received list of news content items may be accompanied by a specific consumer identifier corresponding to the consumer identifier included in the specific consumer profile 210. In an even further embodiment, the method 500 may further include identifying, in the profile database 208, the specific consumer profile 210 based on the received specific consumer identifier prior to identifying the one or more news content items. In another even further embodiment, the received list of news content items and specific consumer identifier may be included in a filtering request, and the filtered list of news content items may be transmitted as a response to the received filtering request.

### Computer System Architecture

FIG. 6 illustrates a computer system 600 in which embodiments of the present disclosure, or portions thereof, may be implemented as computer-readable code. For example, the processing server 108 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3 and 5.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3 and 5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

Techniques consistent with the present disclosure provide, among other features, systems and methods for filtering news content. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for filtering news content, comprising:
storing, in a profile database, a consumer profile, wherein the consumer profile includes data related to a consumer;
storing, in the consumer profile, a plurality of transaction data entries, wherein each transaction data entry includes data related to a payment transaction involving the related consumer including at least a merchant identifier and transaction data;
receiving, by a receiving device, a list of news content items, wherein the list of news content items includes data related to a plurality of news content items including at least publication data;
identifying, by a processing device, one or more news content items in the list of news content items where the included publication data corresponds to at least one of the merchant identifier and transaction data in one or more transaction data entries stored in the consumer profile;
filtering, by the processing device, the identified one or more news content items out of the list of news content items; and
transmitting, by a transmitting device, the filtered list of news content items.

2. The method of claim 1, wherein the filtered list of news content items is transmitted to a display device for display to the related consumer.

3. The method of claim 1, wherein the publication data includes a merchant identifier associated with an entity associated with publishing of the corresponding news content item.

4. The method of claim 1, wherein the publication data and transaction data include at least one of: a publication name, publication identifier, volume name, volume identifier, article name, article identifier, author name, and author identifier.

5. The method of claim 1, wherein
the stored consumer profile is a specific consumer profile of a plurality of consumer profiles stored in the profile database, and
each consumer profile includes a consumer identifier.

6. The method of claim 5, wherein the received list of news content items is accompanied by a specific consumer identifier corresponding to the consumer identifier included in the specific consumer profile.

7. The method of claim 6, further comprising:
identifying, in the profile database, the specific consumer profile based on the received specific consumer identifier prior to identifying the one or more news content items.

8. The method of claim 6, wherein
the received list of news content items and specific consumer identifier are included in a filtering request, and
the filtered list of news content items is transmitted as a response to the received filtering request.

9. The method of claim 1, wherein the consumer profile further includes a list of subscribed publications.

10. The method of claim 9, wherein the one or more news content items that is filtered out includes at least one news content item where the included publication data corresponds to a subscribed publication in the list of subscribed publications.

11. A system for filtering news content, comprising:
a profile database configured to store a consumer profile, wherein the consumer profile includes data related to a consumer including a plurality of transaction data entries, wherein each transaction data entry includes data related to a payment transaction involving the related consumer including at least a merchant identifier and transaction data;
a receiving device configured to receive a list of news content items, wherein the list of news content items includes data related to a plurality of news content items including at least publication data;
a processing device configured to
identify one or more news content items in the list of news content items where the included publication data corresponds to at least one of the merchant identifier and transaction data in one or more transaction data entries stored in the consumer profile, and
filter the identified one or more news content items out of the list of news content items; and
a transmitting device configured to transmit the filtered list of news content items.

12. The system of claim 11, wherein the filtered list of news content items is transmitted to a display device for display to the related consumer.

13. The system of claim 11, wherein the publication data includes a merchant identifier associated with an entity associated with publishing of the corresponding news content item.

14. The system of claim 11, wherein the publication data and transaction data include at least one of: a publication name, publication identifier, volume name, volume identifier, article name, article identifier, author name, and author identifier.

15. The system of claim 11, wherein
the stored consumer profile is a specific consumer profile of a plurality of consumer profiles stored in the profile database, and
each consumer profile includes a consumer identifier.

16. The system of claim 15, wherein the received list of news content items is accompanied by a specific consumer identifier corresponding to the consumer identifier included in the specific consumer profile.

17. The system of claim 16, wherein the processing device is further configured to identify, in the profile database, the specific consumer profile based on the received specific consumer identifier prior to identifying the one or more news content items.

18. The system of claim 16, wherein
the received list of news content items and specific consumer identifier are included in a filtering request, and
the filtered list of news content items is transmitted as a response to the received filtering request.

19. The system of claim 11, wherein the consumer profile further includes a list of subscribed publications.

20. The system of claim 19, wherein the one or more news content items that is filtered out includes at least one news content item where the included publication data corresponds to a subscribed publication in the list of subscribed publications.
